(19) United States
(12) Patent Application Publication
(10) Pub. No.: US 2025/0158333 A1
(43) Pub. Date: May 15, 2025

(54) Connector and Connector Assembly

(71) Applicant: TE Connectivity Japan G.K., Kawasaki-shi (JP)

(72) Inventors: Masaaki Iwasaki, Kawasaki-shi (JP); Junya Tsuji, Kawasaki-shi (JP); Tetsuya Katano, Kawasaki-Shi (JP); Hiroshi Fukuzaki, Kawasaki-Shi (JP); Yoshihiko Kodaira, Kawasaki-Shi (JP); Masamune Iwasaki, Kawasaki-Shi (JP); Koji Tanaka, Kawasaki-Shi (JP)

(73) Assignee: TE Connectivity Japan G.K., Kawasaki-shi (JP)

(21) Appl. No.: 18/946,062

(22) Filed: Nov. 13, 2024

(30) Foreign Application Priority Data
Nov. 13, 2023 (JP) 2023-192938

(51) Int. Cl. H01R 13/6471; H01R 12/70; H01R 12/71; H01R 13/518

(52) U.S. Cl. CPC H01R 13/6471; H01R 12/7064; H01R 12/716; H01R 13/518

(57) ABSTRACT

An electrical connector to be connected to a circuit board includes a plurality of signal contacts, a plurality of ground contacts, a wafer, an organizer, and at least one ground member. The wafer supports a plurality of the signal contacts and a plurality of the ground contacts. The organizer attached to the wafer and is in electrical contact with a plurality of the ground contacts. The at least one ground member is attached to the organizer and is in electrical contact with the organizer. The ground member formed with a plurality of spring bodies adapted to be brought into contact with the circuit board.

### CROSS-REFERENCE TO RELATED APPLICATION

This application claims the benefit of Japanese Patent Application No. 2023-192938 filed on Nov. 13, 2023, the whole disclosure of which is incorporated herein by reference.

### FIELD OF THE DISCLOSURE

The present disclosure relates to an electrical connector to be connected to a circuit board.

### BACKGROUND OF THE INVENTION

In a server and/or a router in a connection system used for the purpose of data communication at a data center or the like, two circuit boards may be required to be connected together while being oriented at a 90-degree angle to each other. In this case, a male connector and a female connector are connected to the two circuit boards, respectively, and the two circuit boards are connected together by connecting the male connector and the female connector. Electrical connectors of this type have signal contacts for signal transmission and ground contacts for ground (GND) densely arranged therein. The electrical connectors of the prior art are composed of as many wafers for supporting the signal contacts and the ground contacts as needed, stacked one on top of another. These connection assemblies of an electrical connector and circuit board including signal contacts and ground contacts at high density, are required to have a high data transfer speed, as well as to stabilize a ground electrical connection between the electrical connector and the circuit board while ensuring respective functions of connection portions of the signal contacts and the other signal contacts.

### SUMMARY OF THE INVENTION

According to an embodiment of the present disclosure, an electrical connector to be connected to a circuit board includes a plurality of signal contacts, a plurality of ground contacts, a wafer, an organizer, and at least one ground member. The wafer supports a plurality of the signal contacts and a plurality of the ground contacts. The organizer attached to the wafer and is in electrical contact with a plurality of the ground contacts. The at least one ground member is attached to the organizer and is in electrical contact with the organizer. The ground member formed with a plurality of spring bodies adapted to be brought into contact with the circuit board.

### BRIEF DESCRIPTION OF DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 is a diagram showing an electrical connector according to a first embodiment;

FIG. 2 is a diagram showing a relationship between the electrical connector and a circuit board according to the first embodiment;

FIG. 3 is a diagram showing a relationship between a ground member and a ground of the circuit board according to the first embodiment;

FIG. 4 shows a diagram of the electrical connector according to the first embodiment, with the ground member mounted on the ground of the circuit board;

FIG. 5 is an isometric view showing part of the circuit board according to the first embodiment;

FIG. 6 is an isometric view showing signal contacts, ground contacts, and part of an organizer of the electrical connector according to the first embodiment;

FIG. 7 is a diagram showing the organizer and the ground member according to the first embodiment;

FIG. 8 is a diagram showing an organizer and a ground member according to a second embodiment;

FIG. 9 is a diagram showing an organizer and a ground member according to a third embodiment; and

FIG. 10 is an isometric view showing signal contacts, ground contacts, and part of an organizer and a ground member of an electrical connector according to a fourth embodiment.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details.

In other instances, well-known structures and devices are schematically shown in order to simplify the drawing.

A connection assembly of an electrical connector and circuit board according to embodiments of the present invention will be described below with reference to the accompanying drawings. This connection means involving an electrical connection and a mechanical connection.

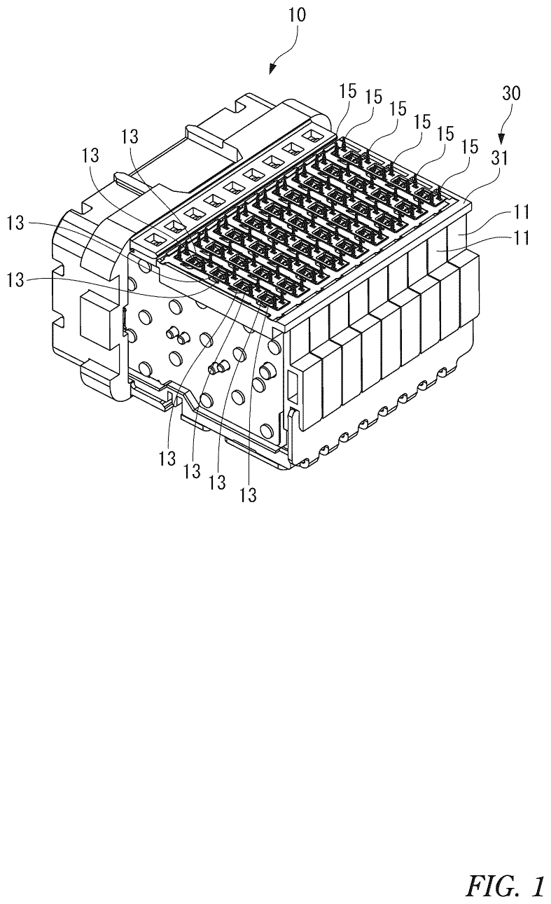

### First Embodiment: See FIGS. 1 to 7

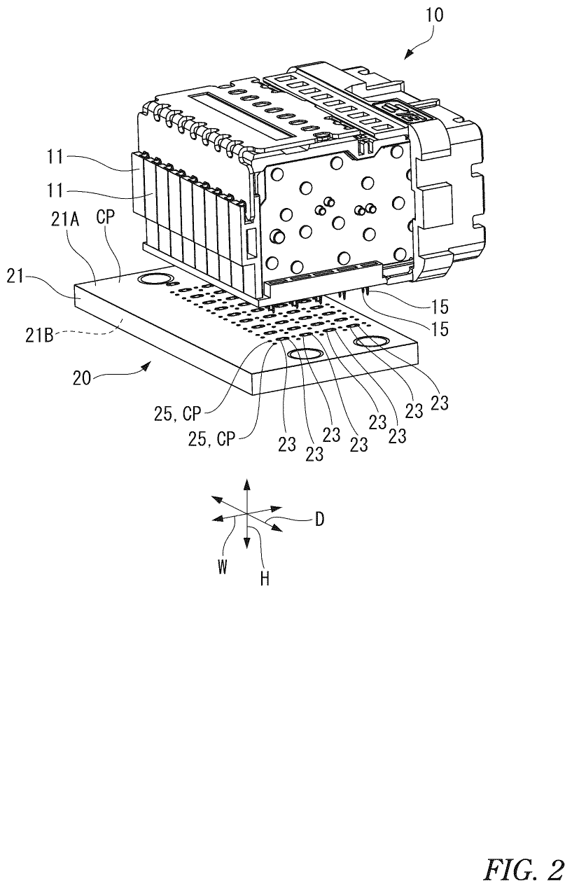

An electrical connector 10 of the first embodiment, as shown in FIG. 1, includes a wafer 11, a plurality of signal contacts 13, a plurality of ground contacts 15, and an organizer 30. In addition, as shown in FIG. 2, the electrical connector 10 is connected to a circuit board 20, thereby forming a connection assembly. Though not shown, in one example, the electrical connector 10 and another electrical connector are mated together, thereby providing a DPO (Direct Plug Orthogonal) configuration in which the circuit board 20 and another circuit board are oriented orthogonally to each other. In the DPO configuration, an electrical signal to be sent and received between the circuit board 20 of the connection assembly of the present embodiment and a circuit board of another connection assembly is delivered between the electrical connector 10 and another electrical connector. The electrical connector 10 in accordance with the present embodiment includes the organizer 30 having electrical continuity with the plurality of ground contacts 15, and at least one ground plate 40, as a ground member, attached to the organizer 30 and having electrical continuity with the organizer 30, and the ground plate 40, as the ground member, is formed with a plurality of flat springs 42, as a plurality of spring bodies, brought into contact with the circuit board 20.

### <Electrical Connector 10: See FIGS. 1, 2, 3, 6>

The electrical connector 10 is composed of a plurality of wafers 11 stacked one on top of another. To describe a general configuration example of the wafer 11, the wafer 11 includes two wiring boards and two shield boards. The wiring boards and the shielding boards have a generally rectangular shape as viewed from above.

The two wiring boards are a plate-like member having metal wiring insert-molded in a resin plate, the metal wiring being composed of an arrangement of a plurality of individual wires. Each of the individual wires constituting the metal wiring is formed with a contact at one end, the contact being brought into contact with a contact of another electrical connector that is a mating connector. Each of these individual wires also has a plurality of spring-contact type signal contacts 13 arranged at the other end, the signal contact 13 being brought into electrical contact with a corresponding one of a plurality of signal electrode pads 23 formed on the circuit board 20 (FIG. 2). It should be noted that the signal electrode pad 23 is equivalent to a signal electrode of the present invention.

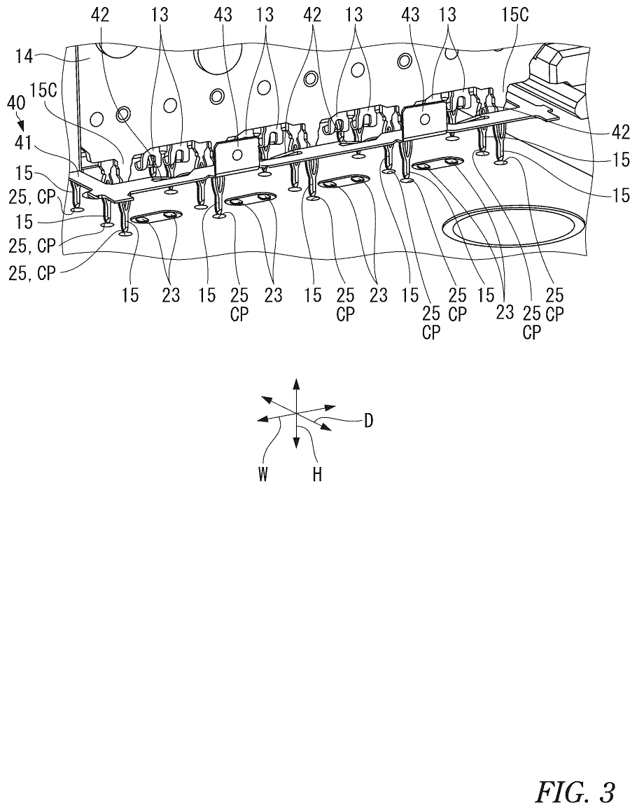

The two shield boards are so arranged as to sandwich the two wiring boards stacked one on top of the other from opposite sides. Each of these two shield boards has a plurality of ground contacts arranged on one side face, the plurality of ground contacts being connected to ground contacts of another electrical connector that is a mating counterpart. These two shield boards 14 have the plurality of ground contacts 15 on the other side face, the plurality of ground contacts 15 being inserted into a plurality of through-hole electrodes 25 as a plurality of ground electrodes (FIG. 3). The through-hole electrode 25 functions as a ground electrode formed in the circuit board 20.

A spring-contact type contact, in one example, is used as the signal contact 13. A side closer to a contact-point portion of the signal contact 13 is defined as a distal end. When the contact point portion is pressed against the signal electrode pad 23 in the course of assembling the electrical connector 10 and the circuit board 20 together, the contact point portion is brought into spring contact with the signal electrode pad 23.

The signal contact 13 is formed, for example by stamping and forming a sheet material made of a copper alloy having electrical conductivity and excellent elasticity. The same applies to the ground contact 15.

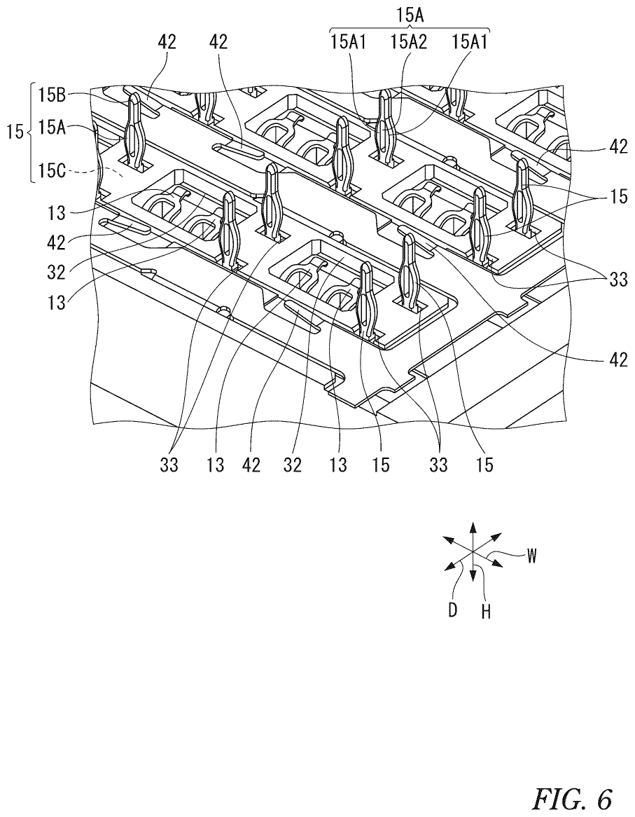

A press-fit type contact, in one example, is used as the ground contact 15. The ground contact 15 is also called a needle-eye type contact and as shown in FIG. 6, is composed of a press-fit portion 15A, a guide portion 15B continuous with one end of the press-fit portion 15A, and a base portion 15C continuous with the other end of the press-fit portion 15A. The press-fit portion 15A includes a pair of elastic spring-contact beams 15A1, 15A1, and a void 15A2 between the elastic spring-contact beams 15A1, 15A1. The elastic spring-contact beams 15A1, 15A1 each have a both-end supported structure, and are so formed as to be curved outward in an arcuate shape with the void 15A2 therebetween. Therefore, the elastic spring-contact beams 15A1, 15A1 are elastically deformable in such a manner that they are deflected inward or outward with the void 15A2 therebetween. In addition, when the ground contact 15 is inserted into the through-hole electrode 25, the elastic spring-contact beams 15A1, 15A1 are elastically deformed inward using the void 15A2 as a deflection void, and their reaction forces cause an outer peripheral face of each of the elastic spring-contact beams 15A1, 15A1 to be pressed against the through-hole electrode 25.

### <Circuit Board 20: See FIGS. 2, 3, 5>

The circuit board 20 includes a board body 21 having a front face 21A and a rear face 21B, the plurality of signal electrode pads 23 formed on the front face 21A of the board body 21, and the plurality of through-hole electrodes 25 so formed as to pass through the front face 21A and the rear face 21B of the board body 21.

The board body 21 is composed of a plurality of board materials stacked one on top of another. The board material is formed with signal paths, not shown, connected to the plurality of signal electrode pads 23 formed on the front face 21A.

The board body 21 is formed with a conductive film CP made by plating, for example, on the front face 21A, except around the pair of signal electrode pads 23, 23 arranged adjacently, and around an opening of a non-plated through-hole.

The signal contact 13 of the electrical connector 10 assembled on to the circuit board 20 is brought into spring contact with the signal electrode pad 23, so that an electrical signal is sent and received between the electrical connector 10 and the circuit board 20. It should be noted that the signal electrode pads 23 shown in FIGS. 2, 3, and 5 are on the front face 21A of the board body 21, and the signal paths involved in sending and receiving of the electrical signal, which are each electrically connected to a corresponding one of the plurality of signal electrode pads 23, are formed inside the board body 21 along a planar direction of the board body 21. These signal paths are so formed as to avoid the through-hole electrodes 25.

It should be noted that, though the example is shown here in which the signal electrode pad 23 is used to make an electrical connection with the spring-contact type signal contact 13, the signal contact 13 may be of a press-fit type, like the ground contact 15, and this press-fit type signal contact 13 may be inserted into a through-hole electrode formed in the circuit board 20. However, the signal electrode pad 23 has an advantage in terms of ensuring mechanical strength of the board body 21 since it is unnecessary to form a through-hole in the board body 21, and, additionally, the signal paths can be formed inside the board body 21 even with the signal electrode pads 23 formed on the front face 21A.

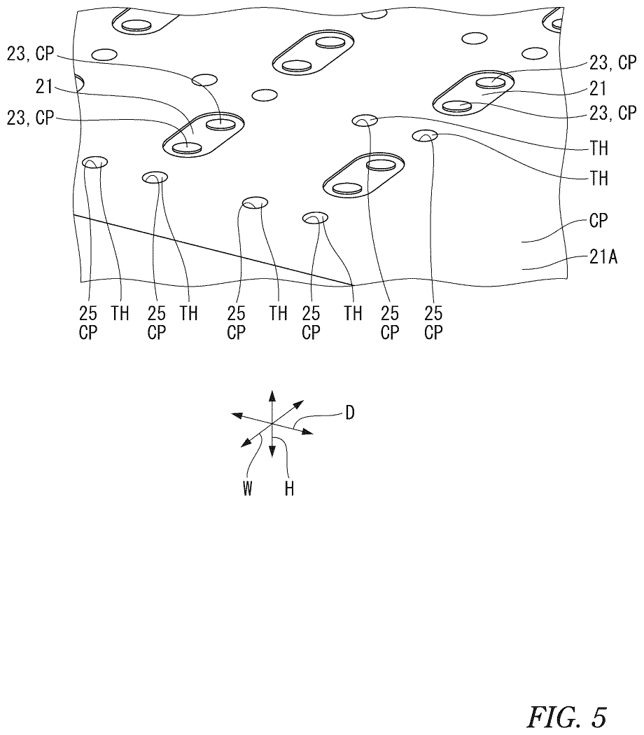

The through-hole electrode 25, as shown in FIG. 5, is composed of a through-hole TH formed in the board body 21, and a conductive film CP made by plating, for example, formed on a wall face in a thickness direction of the board body 21 enclosing the through-hole TH. Typically, the conductive film CP is also formed around openings of the through-hole electrode 25 in the front face 21A and in the rear face 21B.

When the ground contact 15 is inserted into the through-hole electrode 25, the elastic spring-contact beams 15A1, 15A1 of the press-fit portion 15A shown in FIG. 6 are elastically deformed toward the inside void. Their reaction forces cause the outer peripheral face of each of the elastic spring-contact beams 15A1, 15A1 to be pressed against the conductive film CP of the through-hole electrode 25, so that a ground (GND) is provided between the electrical connector 10 and the circuit board 20.

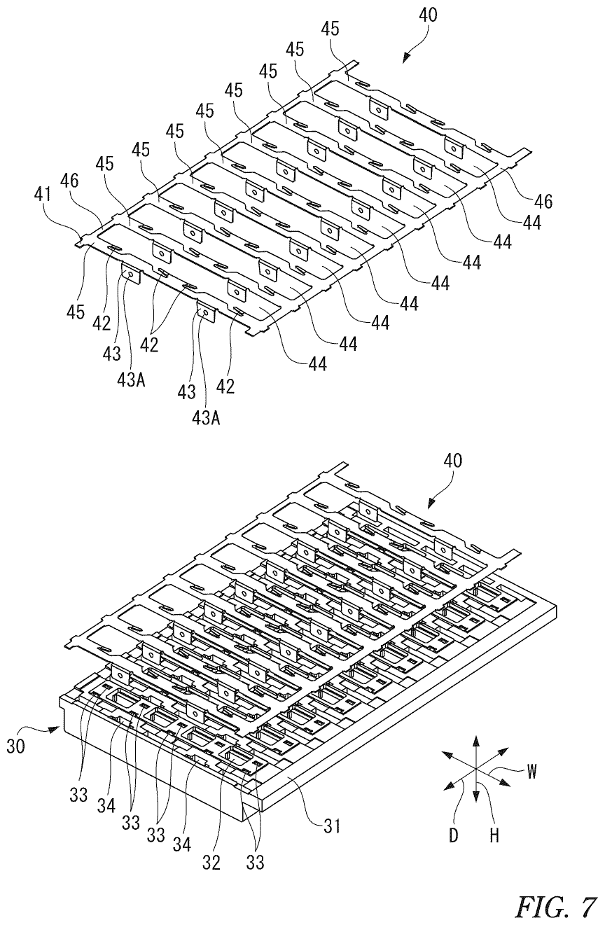

### <Organizer 30: See FIGS. 6, 7>

The organizer 30 functions as a ground (GND) between the circuit board 20 and the ground contact 15 via the ground plate 40 as the ground member, and they are at the same electrical potential.

The organizer 30, in one example, is formed as a unit by injection-molding a resin material that is an electrically insulating material. In addition, the organizer 30 has a conductive film CP made by plating formed on a portion having electrical continuity with the ground contact 15 and on a portion attached to the ground plate 40 as the ground member. In the present embodiment, the conductive film CP made by plating is formed on the entire surface of the organizer 30.

Gold plating or silver plating is used as plating for forming the conductive film CP. The conductive film CP, however, is not limited to plating, and a conductive film CP made by another means, for example, vapor deposition, sputtering, or the like, can be used. The signal electrode pad 23 is also formed from a similar conductive film.

It should be noted, for the convenience of illustration, a width direction W, a length direction D, and a height direction H are defined as shown in FIG. 6.

The organizer 30, as shown in FIG. 7, includes an organizer body 31, accommodation spaces 32, insertion holes 33, and gap portions 34. The accommodation spaces 32, the insertion holes 33, and the gap portions 34 are each arranged in a grid-like pattern or in a matrix in the width direction W and the length direction D.

The accommodation space 32 is a void passing through the organizer 30 in the height direction H, and a pair of signal contacts 13, 13 are accommodated in this void.

The insertion hole 33 has a rectangular opening shape and passes through the front and rear of the organizer 30, and the ground contact 15 is inserted therethrough. The insertion holes 33 are provided in pairs, and the two insertion holes 33 are spaced from each other in the length direction D. Therefore, as a whole, the plurality of insertion holes 33 are arranged in the length direction D and the width direction W. The organizer 30 also includes a press-fit support portion, though not shown, located deeper therein than the insertion hole 33, the base portion 15C of the ground contact 15 being press-fitted into the press-fit support portion. When the base portion 15C is press-fitted into the press-fit support portion, the press-fit portion mechanically restrains the base portion 15C, thereby positioning the ground contact 15. In addition, the base portion 15C of the ground contact 15 is press-fitted into the press-fit support portion, so that the conductive film CP formed on the entire surface of the organizer 30 is electrically connected to the ground contact 15.

The gap portion 34 is a gap passing through the organizer 30 in the height direction H, and the ground plate 40 as the ground member is attached to this gap.

### <Ground Plate 40: FIGS. 3, 4, 7>

The ground plate 40 as the ground member functions as a ground (GND) between the circuit board 20 and the ground contacts 15 via the conductive film CP formed on the organizer 30, and they are at the same electrical potential.

The ground plate 40, as shown in FIG. 7, includes the ground plate body 41, the plurality of flat springs 42 as a plurality of spring bodies brought into contact with the circuit board 20, and a plurality of attachment portions 43.

The ground plate 40 is formed, for example by stamping and forming a sheet material made of a copper alloy having electrical conductivity and excellent elasticity.

When the ground plate body 41 in the present embodiment is viewed from above, the ground plate body 41 has a generally ladder-like shape. The ladder-like ground plate body 41 is composed of a width member 45 equivalent to a rung of a ladder, and a length member 46 equivalent to a beam of a ladder. In the present embodiment, the ladder-like ground plate body 41 is composed of nine width members 45 and two length members 46. The plurality of width members 45 are arranged at equal intervals in the length direction D. The pair of length members 46 are connected to opposite ends in the width direction W of the plurality of width members 45.

An opening enclosed by two adjacent width members 45 and the two length members 46 of the ground plate body 41 is an arrangement space 44 in which the accommodation spaces 32 and the two insertion holes 33 arranged in the width direction W are arranged. A plurality of arrangement spaces 44 are arranged in the length direction D of the ground plate body 41. The width members 45 are provided generally in parallel with the accommodation spaces 32 and the two insertion holes 33 arranged in the width direction W.

The width member 45 is formed with a plurality of flat springs 42 as the plurality of spring bodies brought into contact with the circuit board 20, and two attachment portions 43. The flat springs 42 are formed in such a manner that, when the ground plate 40 is attached to the organizer 30, one flat spring 42 is located to a side in the length direction D of an accommodation space 32 accommodating a pair of signal contacts 13, 13. Since one flat spring 42 is formed for each of a plurality of pairs of signal contacts 13, 13 arranged in the length direction D, the flat springs 42 are arranged on opposite sides in the length direction D of the pair of signal contacts 13, 13. In addition, since the ground contacts 15 are arranged on opposite sides in the width direction W of the pair of the signal contacts 13, 13, when the electrical connector 10 and the circuit board 20 are connected together, the ground between the electrical connector 10 and the circuit board 20 functions around a connection portion between the signal contacts 13 and the signal electrode pads 23. This enables the connection assembly of the electrical connector 10 and the circuit board 20 to have a shield function around signal contact zones to provide impedance adjustment.

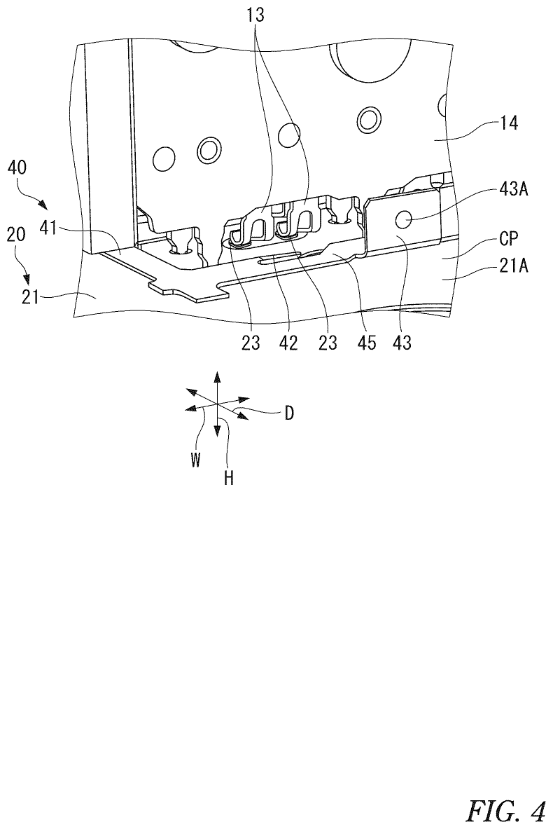

The flat spring 42, in the present embodiment, is so formed as to have a cantilever-like supported structure, and a free end of the cantilever-like supported structure extends toward the circuit board 20. As shown in FIG. 4, when the electrical connector 10 and the circuit board 20 are connected together, a side closer to the free end of the flat spring 42 having the cantilever-like supported structure is brought into contact with the conductive film CP formed on the front face 21A of the circuit board 20, so that the ground functions between the electrical connector 10 and the circuit board 20. Since the ground functions when the flat spring 42 is brought into contact with the circuit board 20 at any position in the width direction W of a portion of the cantilever-like supported structure extending toward the circuit board 20, electrical connection reliability is enhanced. It should be noted that, though the free end of the cantilever-like supported structure extends toward the circuit board 20 in the present embodiment, the present invention is not limited to this, and, for example, at least a portion of the cantilever-like supported structure may extend toward the circuit board 20, like a structure where a portion of the cantilever-like supported structure extends toward the circuit board 20, and then the distal side of the free end hangs down.

In addition, when the electrical connector 10 and the circuit board 20 are connected together, the side closer to the free end of the flat spring 42 having the cantilever-like supported structure is pressed against the circuit board 20, so that stress is generated in the flat spring 42 having the cantilever-like supported structure.

The flat springs 42, in the present embodiment, have a shape tapered toward the free end of the cantilever-like supported structure. Such a flat spring 42 has a rigidity decreasing in the thickness direction of the flat spring 42 from the supported end from the free end. Therefore, when the flat spring 42 is pressed against the circuit board 20, a lower rigidity region closer to the free end of the flat spring 42 is deflected following the circuit board 20, so that the flat spring 42 is easily brought into surface contact with the circuit board 20. In addition, the presence of the supported end portion having higher rigidity can ensure pressure with which the flat spring 42 is brought into contact with the circuit board 20, so that a stable surface contact between the flat spring 42 and the circuit board 20 is achieved, and a stable electrical connection between a connection portion between the electrical connector 10 and the circuit board 20 can be maintained.

When the electrical connector 10 and the circuit board 20 are connected together by the flat spring 42, even if thermal expansion and thermal contraction due to a change in temperature, vibration, or the like causes a slight displacement of the connection portion between the electrical connector 10 and the circuit board 20 in the height direction H in FIG. 4, the flat spring 42 is elastically deformed to follow the displacement occurring in the height direction H, so that such a ground function between the electrical connector 10 and the circuit board 20 as around the connection portion between the signal contact 13 and the signal electrode pad 23 is maintained. Therefore, the ground plate 40 as the ground member can maintain a stable electrical connection between the organizer 30 formed with the conductive film CP and the conductive film CP formed on the front surface 21A of the circuit board 20.

In addition, when the electrical connector 10 and the circuit board 20 are connected together, the flat spring 42 of the ground plate 40 causes a reaction force that tries to separate the electrical connector 10 and the circuit board 20 from each other. However, when the ground contact 15 is inserted into the through-hole electrode 25, the elastic spring-contact beams 15A1, 15A1 of the press-fit portion 15 are elastically deformed toward the inside void, and their reaction forces causes the outer peripheral face of each of the elastic spring-contact beams 15A1, 15A1 to be pressed against the conductive film CP of the through-hole electrode 25, so that a retention force for the connection portion between the electrical connector 10 and the circuit board 20 against the reaction force due to the flat spring 42 of the ground plate 40 can be created.

In the present embodiment, the press-fit type ground contact 15 and the spring-contact type signal contact 13 are illustrated as an electrical connection, but, as described above, the signal contact 13 may be of a press-fit type, like the ground contact 15, so that the retention force for the connection portion between the electrical connector 10 and the circuit board 20 against the reaction force due to the flat spring 42 of the ground plate can be further increased. This enables the connection portion between the electrical connector 10 and the circuit board 20 to maintain an electrical connection further stably.

The ground plate 40 is attached to the organizer 30 by inserting the attachment portion 43 into the gap portion 34 of the organizer 30. The attachment portion 43, as shown in FIG. 7, is so formed as to extend perpendicularly to a plane of the width member 45. In the present embodiment, two attachment portions 43 are formed on each width member 45. In addition, in order to enhance attachment stability when the attachment portion 43 is inserted into the gap portion 34 of the organizer 30, the attachment portion 43 is formed with a protrusion 43A near a center in the height direction H and the width direction W of the attachment portion 43. In the present embodiment, one protrusion 43A is formed on each attachment portion 43, but in order to enhance the attachment stability further, two or more protrusions 43A may be formed on each attachment portion 43.

When the ground plate 40 is viewed from above, the flat spring 42 is formed on one side in the length direction D of the width member 45, and the attachment portion 43 is formed on the other side in the length direction D of the width member 45. In the width direction W of the width member 45, the flat springs 42 and the attachment portions 43 are formed alternately with each other. In addition, the attachment portion 43 is so formed as to be located to a side in the length direction D of the two ground contacts 15 when the ground plate 40 is attached to the organizer 30.

One ground plate 40 is attached to one organizer 30. Therefore, the process of attaching the ground plate 40 to the organizer 30 is simplified.

### <Advantageous Effects Produced by the Electrical Connector 10>

The electrical connector 10 according to the first embodiment described above provides the following advantageous effects.

The electrical connector 10 includes a ground plate 40 as at least one ground member attached to an organizer 30 and having electrical continuity with the organizer 30, and the ground plate 40 as the ground member is formed with a plurality of flat springs 42 as a plurality of spring bodies.

Therefore, when the electrical connector 10 and a circuit board 20 are connected together, even if thermal expansion and thermal contraction due to a change in temperature, vibration, or the like causes a slight displacement of a connection portion between the electrical connector 10 and the circuit board 20, the flat spring 42 is elastically deformed to follow the displacement occurring, so that such a ground function between the electrical connector 10 and the circuit board 20 as around a connection portion between a signal contact 13 and a signal electrode pad 23 is maintained. Therefore, the ground plate 40 as the ground member can maintain a stable electrical connection between the organizer 30 formed with a conductive film CP and the circuit board 20.

In addition, in the electrical connector 10, the plurality of flat springs 42 as the plurality of spring bodies are each so formed as to have a cantilever-like supported structure, and at least a portion of the cantilever-like supported structure extends toward the circuit board 20.

Therefore, the ground functions when the spring 42 is brought into contact with the circuit board 20 at any position in the width direction W of a portion of the cantilever-like supported structure extending toward the circuit board 20, so that electrical connection reliability can be enhanced.

In the electrical connector 10, the flat spring 42 has a shape tapered toward a free end of the cantilever-like supported structure. Such a flat spring 42 has a rigidity in the thickness direction of the flat spring 42 decreasing from a supported end toward the free end. Therefore, when the flat spring 42 is pressed against the circuit board 20, a region closer to the free end having a lower rigidity of the flat spring 42 is deflected following the circuit board 20, so that the flat spring 42 is easily brought into surface contact with the circuit board 20. In addition, the presence of the supported end portion having a higher rigidity can ensure pressure with which the flat spring 42 is brought into contact with the circuit board 20, so that a stable surface contact between the flat spring 42 and the circuit board 20 can be achieved, and a stable electrical connection between the connection portion between the electrical connector 10 and the circuit board 20 can be maintained.

Though the flat spring 42 is so formed as to have a cantilever-like supported structure, and at least a portion of the cantilever-like supported structure extends toward the circuit board 20, the present invention is not limited to this. The flat spring 42 may be so formed as to have a both-end supported structure, and at least a portion of the flat spring having the both-end supported structure may be so formed as to approach the circuit board 20. The structure of the flat spring having a both-end supported structure also provides an advantageous effect similar to that of the flat spring 42 having a cantilever-like supported structure.

In the electrical connector 10, each ground contact 15 is a press-fit type contact.

Therefore, a retention force for the connection portion between the electrical connector 10 and the circuit board 20 can be created.

In the electrical connector 10, the organizer 30 includes a conductive film CP formed on a portion having electrical continuity with the ground contact 15 and on a portion attached to the ground plate 40 as the ground member, and a molded body made of an electrically insulating material for supporting the conductive film CP.

Therefore, the organizer 30 can be formed as a unit by injection-molding a resin material that is an electrically insulating material, and the conductive film CP can be formed on part of the organizer 30. Such an organizer 30 is more advantageous in terms of costs than an organizer 30 made entirely of an electrically conductive material.

In addition to the above, configurations mentioned in the above embodiment may be selectively adopted or not adopted, or may be modified into another configuration as needed, without departing from the spirit of the present invention.

The present invention may be directed only to the connection assembly of the electrical connector 10 and the circuit board 20. That is, the mating counterpart of the electrical connector 10 is not limited to another electrical connector assembled with another circuit board, and the mating counterpart of the electrical connector 10 may be an electrical connector not connected to a circuit board.

Though the organizer 30 composed of a composite body in which a conductive film CP is formed on a molded body made of a resin material has been shown by way of example, the present invention may have an organizer 30 made entirely of an electrically conductive material. In this case, the organizer 30 can be obtained by injection-molding an electrically conductive resin material, or the organizer 30 may be obtained by MIM of an electrically conductive powdery metal. The conductive resin material itself may not have electrical conductivity, and may be obtained by dispersing electrically conductive powder, fibers, or the like into a resin material.

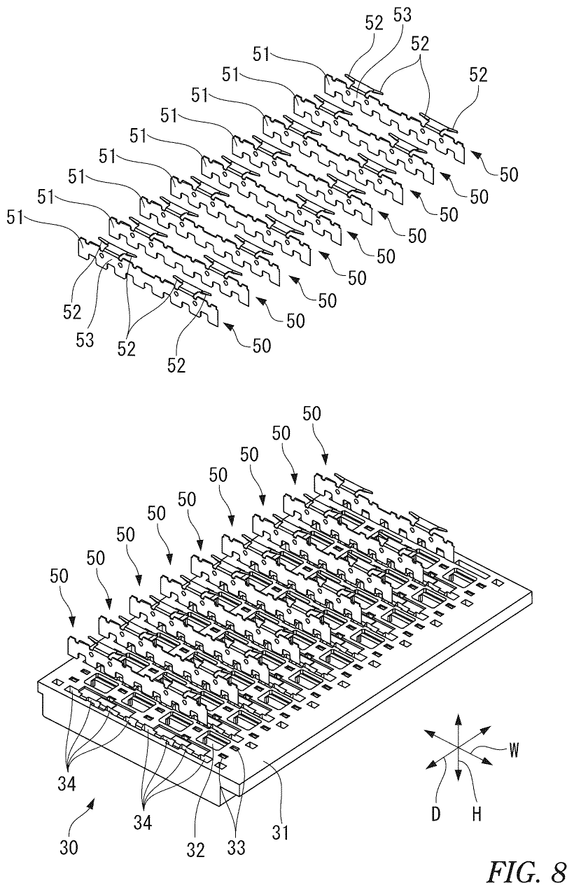

### Second Embodiment: See FIG. 8

A ground plate 50 attached to the electrical connector 10 of a second embodiment, unlike the ground plate 40 formed as a unit attached to the electrical connector 10 of the first embodiment, is so molded as to be divided in the length direction D, and the plurality of ground plates 50 are attached to the electrical connector 10. As shown in FIG. 8, the ground plate 50 includes a ground plate body 51, a plurality of flat springs 52 as a plurality of spring bodies, and an attachment portion 53.

Also in such a ground plate 50, when the electrical connector 10 and the circuit board 20 are connected together, even if thermal expansion and thermal contraction due to a change in temperature, vibration, or the like causes a slight displacement of the connection portion between the electrical connector 10 and the circuit board 20 in the height direction H in FIG. 8, the flat spring 52 is elastically deformed to follow the displacement occurring in the height direction H, so that such a ground function between the electrical connector 10 and the circuit board 20 as around the connection portion between the signal contact 13 and the signal electrode pad 23 is maintained. Therefore, the ground plate 50 as a ground member can maintain a stable electrical connection between the organizer 30 formed with the conductive film CP and the conductive film CP formed on the front surface 21A of the circuit board 20.

In addition, though the ground plate 40 according to the first embodiment is formed as a unit, the ground plate 50 according to the second embodiment is so formed as to be divided in the length direction D. In the present embodiment, the ground plate 50 is divided into nine pieces in the length direction D. The ground plate 50 is formed in such a manner that one ground plate 50 corresponds to one row of the accommodation spaces 32 for accommodating a pair of signal contacts 13, 13 arranged in the width direction W of the organizer 30. For the ground plate 40 according to the first embodiment, a member having a large area, as the ground plate 40 is viewed from above, is required to be processed as a unit, whereas, for the ground plate 50 according to the second embodiment, a member having a small area is processed, so that a small processing machine can be used. In addition, since each ground plate 50 is smaller than the ground plate 40, processing accuracy can be stabilized, so that the ground plate 50 according to the second embodiment is more advantageous in terms of the cost occurring in the processing process than the ground plate 40 according to the first embodiment.

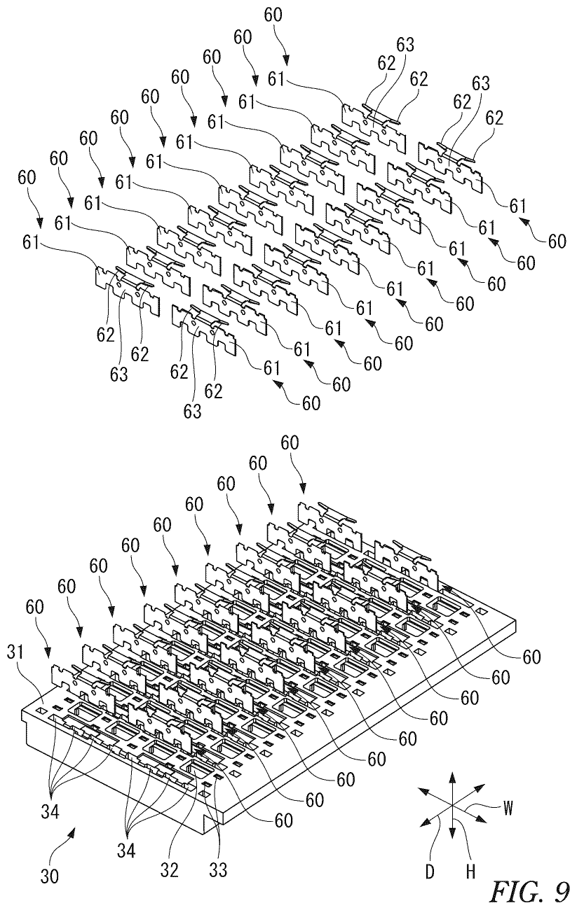

### Third Embodiment: See FIG. 9

Aground plate 60 attached to the electrical connector 10 of a third embodiment, unlike the ground plate 40 formed as a unit attached to the electrical connector 10 of the first embodiment, is so formed as to be divided in the length direction D and divided in the width direction W, and the plurality of ground plates 60 are attached to the electrical connector 10. As shown in FIG. 9, the ground plate 60 includes a ground plate body 61, a plurality of flat springs 62 as a plurality of spring bodies, and an attachment portion 63.

Also in such a ground plate 60, when the electrical connector 10 and the circuit board 20 are connected together, even if thermal expansion and thermal contraction due to a change in temperature, vibration, or the like causes a slight displacement of the connection portion between the electrical connector 10 and the circuit board 20 in the height direction H in FIG. 9, the flat spring 62 is elastically deformed to follow the displacement occurring in the height direction H, so that such a ground function between the electrical connector 10 and the circuit board 20 as around the connection portion between the signal contact 13 and the signal electrode pad 23 is maintained. Therefore, the ground plate 60 as a ground member can maintain a stable electrical connection between the organizer 30 formed with the conductive film CP and the conductive film CP formed on the front surface 21A of the circuit board 20.

In addition, though the ground plate 40 according to the first embodiment is formed as a unit, the ground plate 60 according to the third embodiment is so formed as to be divided into a plurality of pieces in the length direction D and divided into two pieces in the width direction W. In the present embodiment, the ground plate 60 is divided into nine pieces in the length direction D, and divided into two pieces in the width direction W. The ground plate 60 is molded in such a manner that one ground plate 60 corresponds to accommodation spaces 32, 32 adjacent to each other among the accommodation spaces 32 for accommodating a pair of signal contacts 13, 13 arranged in the width direction W of the organizer 30. The ground plate 50 according to the second embodiment is molded in such a manner that one ground plate 50 corresponds to one row of the accommodation spaces 32, whereas, for the ground plate 60 according to the third embodiment, a member having about one half of the area of the ground plate 50 according to the second embodiment is processed. Therefore, a small processing machine can be used. In addition, since each ground plate 60 is smaller than the ground plate 50, the processing accuracy can be further stabilized, so that the ground plate 60 according to the third embodiment is more advantageous in terms of the processing cost than the ground plate 50 according to the second embodiment.

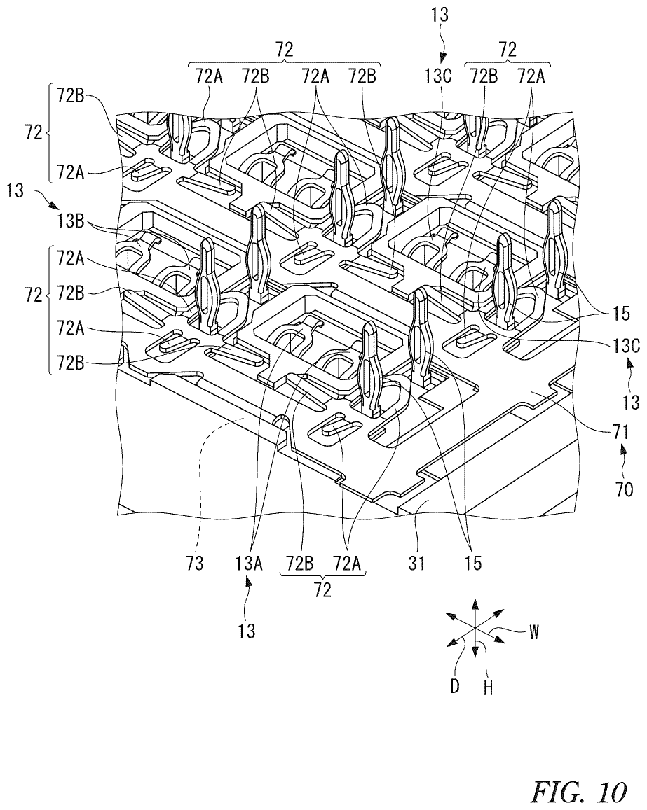

### Fourth Embodiment: See FIG. 10

While the flat spring 42 of the ground plate 40 according to the first embodiment extends in the width direction W, a flat spring 72 of a ground plate 70 attached to the electrical connector 10 of a fourth embodiment is composed of a flat spring 72A extending in the length direction D and a flat spring 72B extending in the width direction W. As shown in FIG. 10, the ground plate 70 includes a ground plate body 71, a plurality of flat springs 72 as a plurality of spring bodies, and a plurality of attachment portions 73. In the present embodiment, the plurality of flat springs 72 are composed of a flat spring 72A extending in the length direction D and in the height direction H, and a flat spring 72B extending in the width direction W and the height direction H. The plurality of flat springs 72A are arranged in the same direction as the ground contacts 15 arranged in the length direction D. This results in a dense arrangement of electrical connection portions between the ground contacts 15 and the through-hole electrodes 25 and electrical connection portions between the flat springs 72A and the conductive film CP of the front face 21A of the circuit board 20. When the ground plate 70 is viewed from above, an adjacent pair of signal contacts 13B, 13B are closer to a pair of signal contacts 13A, 13A than an adjacent pair of signal contacts 13C, 13C, and therefore, in order to ensure that the ground will function, the ground contact 15 and the flat spring 72A are densely arranged between the signal contact 13A and the signal contact 13B.

Since the ground plate 70 according to the present embodiment is processed as a unit, like the ground plate 40 according to the first embodiment, the process of attaching the ground plate 70 to the organizer 30 can be simplified.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. An electrical connector to be connected to a circuit board, comprising:
a plurality of signal contacts;
a plurality of ground contacts;
a body supporting a plurality of the signal contacts and a plurality of the ground contacts;
an organizer attached to the body and in electrical contact with the plurality of the ground contacts; and
at least one ground member attached to the organizer and in electrical contact with the organizer, the ground member formed with a plurality of spring bodies adapted to be brought into contact with the circuit board.

2. The electrical connector according to claim 1, wherein each of a plurality of the spring bodies is formed with a cantilever-like supported structure.

3. The electrical connector according to claim 2, wherein at least a portion of the cantilever-like supported structure of each of the plurality of spring bodies extends toward the circuit board.

4. The electrical connector according to claim 3, wherein each of a plurality of the spring bodies extends in a width direction of the connector.

5. The electrical connector according to claim 4, wherein each of a plurality of the spring bodies extends in a length direction of the connector.

6. The electrical connector according to claim 1, wherein at least one spring body is formed for each pair of the signal contacts.

7. The electrical connector according to claim 1, wherein each of a plurality of the ground contacts is a press-fit type contact.

8. The electrical connector according to claim 1, wherein the organizer includes a conductive film formed on a portion having electrical continuity with the ground contact.

9. The electrical connector according to claim 8, wherein the conductive film is formed on a portion attached to the ground member.

10. The electrical connector according to claim 9, wherein the organizer further includes a molded body made of an electrically insulating material supporting the conductive film.

11. The electrical connector according to claim 1, wherein the signal contact of the electrical connector is adapted to be electrically connected to a signal electrode of the circuit board.

12. The electrical connector according to claim 11, wherein the ground contact of the electrical connector is adapted to be electrically connected to a ground electrode of the circuit board.

13. The electrical connector according to claim 1, wherein the body comprises a wafer.

14. The electrical connector according to claim 13, wherein the wafer includes at least one wiring board and at least one shield board.

15. The electrical connector according to claim 13, wherein the electrical connector includes a plurality of the wafers stacked one on top or another or side by side.

16. A connection assembly, comprising:
a circuit board; and
an electrical connector connected to the circuit board, including:
a plurality of signal contacts;
a plurality of ground contacts;
a wafer supporting a plurality of the signal contacts and a plurality of the ground contacts;
an organizer attached to the wafer an in electrical contact with a plurality of the ground contacts; and
at least one ground member attached to the organizer and in electrical contact with the organizer, the ground member formed with a plurality of spring bodies adapted to be brought into contact with the circuit board.

17. The connection assembly according to claim 16, wherein the circuit board includes a signal electrode, the signal contact of the electrical connector is electrically connected to the signal electrode of the circuit board.

18. The connection assembly according to claim 17, wherein the circuit board includes a ground electrode, the ground contact of the electrical connector is electrically connected to the ground electrode of the circuit board.

19. The connection assembly according to claim 16, wherein each of a plurality of the spring bodies is formed with a cantilever-like supported structure.

20. The connection assembly according to claim 19, wherein at least a portion of the cantilever-like supported structure of each of the plurality of spring bodies extends toward the circuit board.
